(19) United States
(12) Patent Application Publication
(10) Pub. No.: US 2009/0073886 A1
(43) Pub. Date: Mar. 19, 2009

(54) Methods and Computer-Readable Media for Testing a Network Connection at a Computing Device

(76) Inventors: David Joseph Ralph Burns, Ottawa (CA); Norman James Robertson, Kanata (CA)

Correspondence Address: SoCAL IP LAW GROUP LLP, 310 N. WESTLAKE BLVD. STE 120, WESTLAKE VILLAGE, CA, 91362, US

(21) Appl. No.: 12/158,297

(22) PCT Filed: Jan. 25, 2006
(86) PCT No.: PCT/CA2006/000095

§ 371 Date: Nov. 18, 2008

(30) Foreign Application Priority Data
Dec. 23, 2005 (CA) 2531579

(51) Int. Cl. H04L 12/26

(52) U.S. Cl. 370/248

(57) ABSTRACT

A computer-readable medium is provided, comprising a set of instructions for execution by a processor of a computing device at a subscriber premises. The processor is operable to execute a software application that enables the computing device to participate in a media connection over a data network. Execution of the set of instructions by the processor causes the computing device to execute a method that includes performing a connectivity test over a test connection established through a gateway at the subscriber premises and over the data network; and prior to performing a connectivity test, provisioning the gateway to enable establishment of said test connection.

### FIELD OF THE INVENTION

The present invention is related to communication over a network and, in particular, to methods and computer-readable media for testing a network connection at a computing device.

### BACKGROUND

The telecommunications industry has advanced to the point where the majority of residential and business customers can subscribe to a data network service, such as an Internet service. In cases where access to a copper twisted pair is available, the customer may use a modem or a home gateway located at the subscriber premises in order to connect to a service provider's digital subscriber line access multiplexer (DSLAM) in the data network.

Naturally, problems with the customer's connection (known as a “connectivity problems”) may arise. A conventional approach to troubleshooting a connectivity problem reported by a customer consists of the service provider sending a service technician to the customer premises. In order to verify network connectivity, the service technician disconnects the customer's modem or home gateway and, in its place, connects a portable computer pre-loaded with an analysis tool capable of executing an array of tests. Upon completion of the tests, the service technician expects to be in a position to assess the nature of the connectivity problem.

One disadvantage with the aforementioned conventional troubleshooting approach is the fact that the customer's connection is not truly being tested by the service technician. For example, the technician is not running the same software program as the customer was running when the connectivity problem was experienced. Thus, while the service technician may be able to test certain basic connectivity features, he or she may be unable to diagnose the connectivity problem with a sufficient degree of accuracy.

Another disadvantage with the aforementioned conventional troubleshooting approach lies in the need to deploy the service technician in the first place. Specifically, not only does this activity engender a delay before the connectivity problem can even begin to be diagnosed, but it is considered costly in terms of the amount of labour, fuel, etc. that needs to be expended each time a customer experiences a connectivity problem. Moreover, the specialized test devices used by service technicians can be costly as well.

Thus, it should be apparent that conventional troublehsooting techniques are inadequate, especially as service providers come under increased pressure to reduce costs, and also as service providers become more concerned with increasing customer satisfaction.

### SUMMARY OF THE INVENTION

A first broad aspect of the present invention seeks to provide a computer-readable medium comprising a set of instructions for execution by a processor of a computing device at a subscriber premises. The processor is operable to execute a software application that enables the computing device to participate in a media connection over a data network. Execution of the set of instructions by the processor causes the computing device to execute a method that includes performing a connectivity test over a test connection established through a gateway at the subscriber premises and over the data network; and prior to said performing a connectivity test, provisioning the gateway to enable establishment of said test connection.

A second broad aspect of the present invention seeks to provide a method for execution at a computing device located at a subscriber premises. The method comprises executing a software application that enables the computing device to participate in a media connection over a data network; performing a connectivity test over a test connection established through a gateway at the subscriber premises and over the data network; and prior to said performing a connectivity test, provisioning the gateway to enable establishment of said test connection.

A third broad aspect of the present invention seeks to provide a method for execution at a computing device located at a subscriber premises, the computing device being operable for executing a software application that enables the computing device to participate in a media connection over a data network. The method comprises performing a connectivity test over a test connection established through a gateway at the subscriber premises and over the data network; and prior to said performing a connectivity test, provisioning the gateway to enable establishment of said test connection.

A third broad aspect of the present invention seeks to provide a system for testing connectivity over a data network. The system comprises a test end point accessible via the data network; and a computing device operable for executing a software application that enables the computing device to participate in a media connection over the data network. The test end point is operable for issuing a test initiation trigger to the computing device. The computing device is further operable for responding to said test initiation trigger to effect a connectivity test over a test connection established with the test end point, the computing device further operable for, prior to said performing a connectivity test, provisioning the computing device to enable establishment of said test connection.

These and other aspects and features of the present invention will now become apparent to those of ordinary skill in the art upon review of the following description of specific embodiments of the invention in conjunction with the accompanying drawings.

### BRIEF DESCRIPTION OF THE DRAWINGS

In the accompanying drawings:

FIG. 1 shows a network configuration comprising a data network and a subscriber premises;

FIGS. 2A-2C depict establishment of a test connection in accordance with a first non-limiting embodiment of the present invention;

FIG. 3 depicts establishment of a test connection in accordance with a second non-limiting embodiment of the present invention; and

FIGS. 4A-4B depict establishment of a test connection in accordance with a third non-limiting embodiment of the present invention.

It is to be expressly understood that the description and drawings are only for the purpose of illustration of certain embodiments of the invention and are an aid for understanding. They are not intended to be a definition of the limits of the invention.

### DETAILED DESCRIPTION OF EMBODIMENTS

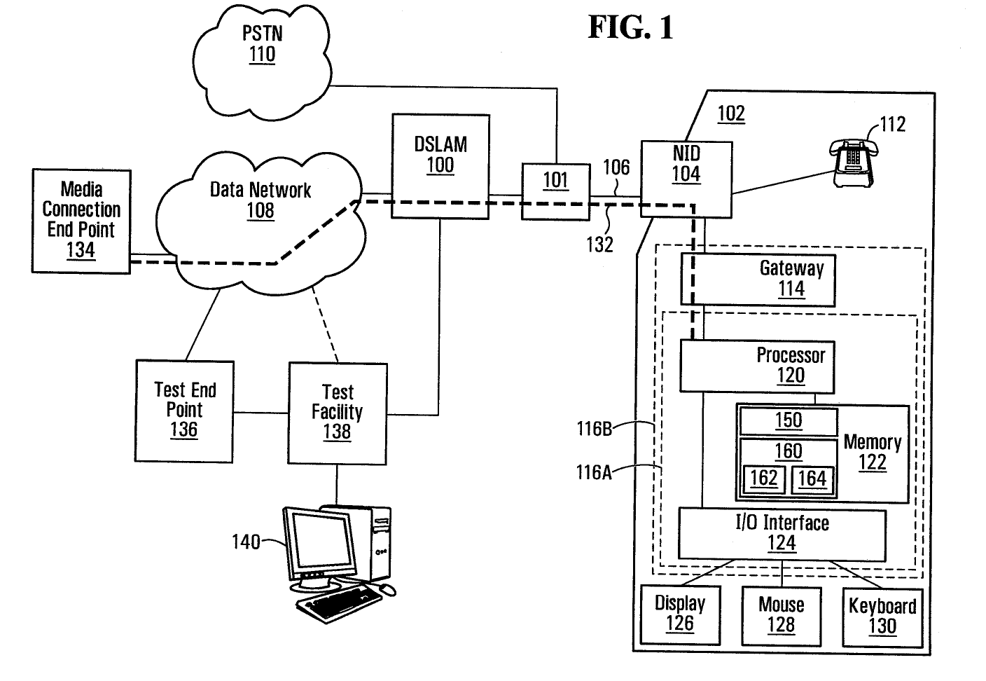

With reference to FIG. 1, there is shown a network configuration in accordance with a specific non-limiting embodiment of the present invention, comprising a DSLAM 100 connected to a subscriber premises 102 via a splitter 101 and a communication link 106, which in a non-limiting example may be a copper twisted pair. Of course, the DSLAM 100 may be connected to additional subscribers premises via other respective splitters and communication links, but these have been omitted from FIG. 1 for the sake of simplicity. The splitter 101 allows data and voice signals to coexist on the same communication link 106. The data signals are exchanged over a data network 108 via the DSLAM 100 while the voice signals are exchanged with the public switched telephone network (PSTN) 110.

In another non-limiting example, applicable to cable television networks over which Internet access is delivered, the communication link 106 can be a coaxial cable, and the DSLAM 100 in FIG. 1 can be replaced by a head-end modem (not shown). In such a case, there is no need for a connection between the head-end modem and the PSTN 110.

The subscriber premises 102 comprises a network interface device 104 for connection to the DSLAM 100 over the communication link 106. At the subscriber premises 102, the network interface device 104, which in one specific non-limiting embodiment may be embodied as a splitter in combination with a filter, connects to a POTS telephone 112 and to a gateway 114. In other specific non-limiting embodiments, e.g., where the communication link 106 is a coaxial cable, the network interface device 104 may simply be a connector.

In one embodiment, the gateway 114 may be implemented as a modem. In another embodiment, the gateway 114 may comprise a router in combination with a modem. In yet another embodiment, the gateway 114 may comprise a router, and a separate modem may be connected between the network interface device 104 and the gateway 114. In other words, the gateway 114 may, depending on the embodiment, be implemented as a modem, a router or a combination of a router and a modem.

The gateway 114 is connected to a computing device 116A, 116B. The computing device 116A, 116B comprises a processor 120, a memory 122, an input/output (I/O) interface 124 and a set of input/output devices for interfacing with a subscriber, such as a display 126, a keyboard 130 and a mouse 128, to name a few. In some embodiments, the computing device 116A does not comprise the gateway 114. In other embodiments, the computing device 11 6B does comprise the gateway 114.

The memory 122 stores computer-readable instructions defining the operation of an operating system as is known in the art, in addition to various software applications that can be executed by the processor 120. One example of a software application that may be stored in the memory 122 for execution by the processor 120 is a media application 150. Another example of a software application that may be stored in the memory 122 is a troubleshooting application 160.

The media application 150 enables the computing device 116A, 116B to participate in a media connection 132 established via the gateway 114 and over the data network 108. The media connection 132 terminates at a media connection end point 134, which may be a server or server farm (in the case of the media application 150 implementing an Internet browser and the media connection 132 being a data connection), a VoIP telephone or a softswitch (in the case of the media application 150 implementing a VoIP soft client and the media connection 132 being a voice-over-packet telephony connection) or a video server (in the case of the media application 150 implementing an IPTV decoder and the media connection 132 being a video connection).

In order to support the media connection 132 and other connections/sessions over the data network 108, the gateway 114 employs a unique public IP address. In one embodiment, the public IP address of the gateway 114 may be static. In another embodiment, the public IP address of the gateway 114 may be dynamic. In the case where the public IP address of the gateway is dynamic, the public IP address may be assigned by an address-assigning entity from a set of available public IP addresses determined by the provider of access to the data network 108. In a non-limiting embodiment, such an address-assigning entity may be a server which implements DHCP (Dynamic Host Configuration Protocol).

It should be appreciated that if the gateway 114 is a modem with limited intelligence, then the public IP address of the gateway 114 may actually apply to the computing device 116A, 116B rather than to the modem. On the other hand, if the gateway 114 implements a more sophisticated modem or a router that interconnects the computing device 116A, 116B to one or more other devices over a local area network (LAN), then the public IP address of the gateway 114 will indeed be assigned to the gateway 114. In these cases, a separate, “private” IP addressing scheme may be used to communicate amongst the various devices in the LAN, such that the various devices, including the gateway 114 and the computing device 116A, 116B, will each have a private IP address. Thus, in fact, the gateway 114 may be associated with two IP addresses, one of which is a public IP address and the other of which is a private IP address.

For security reasons, the gateway 114 and/or the computing device 116A, 116B may run a firewall that oversees operation of the media application 150 and scrutinizes the data exchanged over the media connection 132. Use of a firewall in this fashion will be known to those of skill in the art. The firewall may be implemented as middleware operating between the operating system and the media application 150.

It is expected that the subscriber may occasionally experience problems with the media connection 132. The present invention offers various possibilities for dealing with connectivity problems, as will now be described.

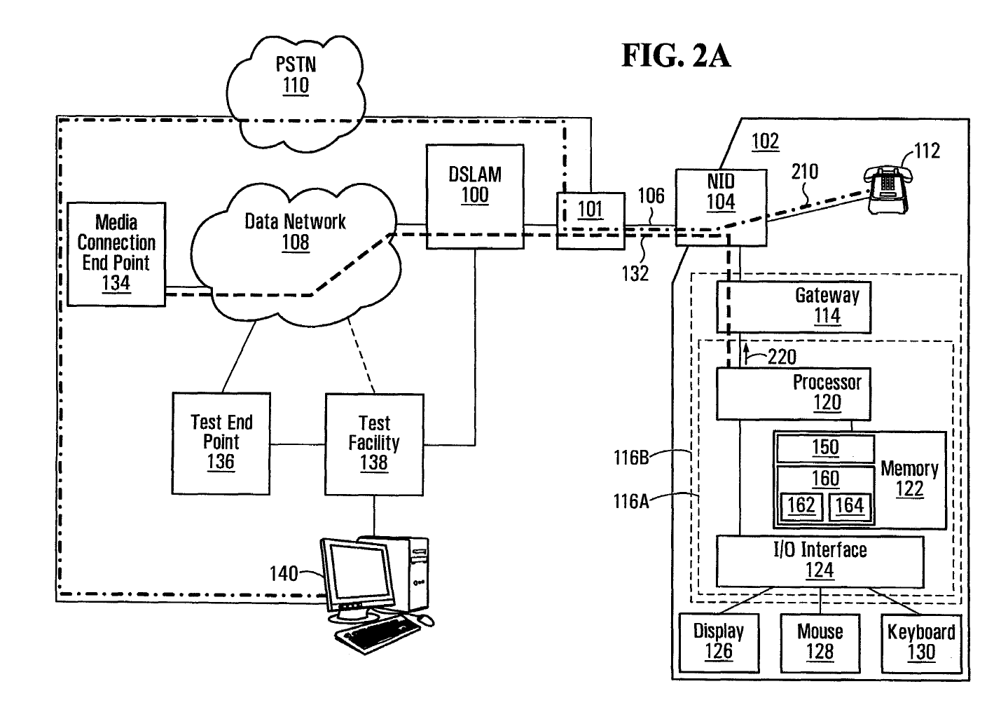

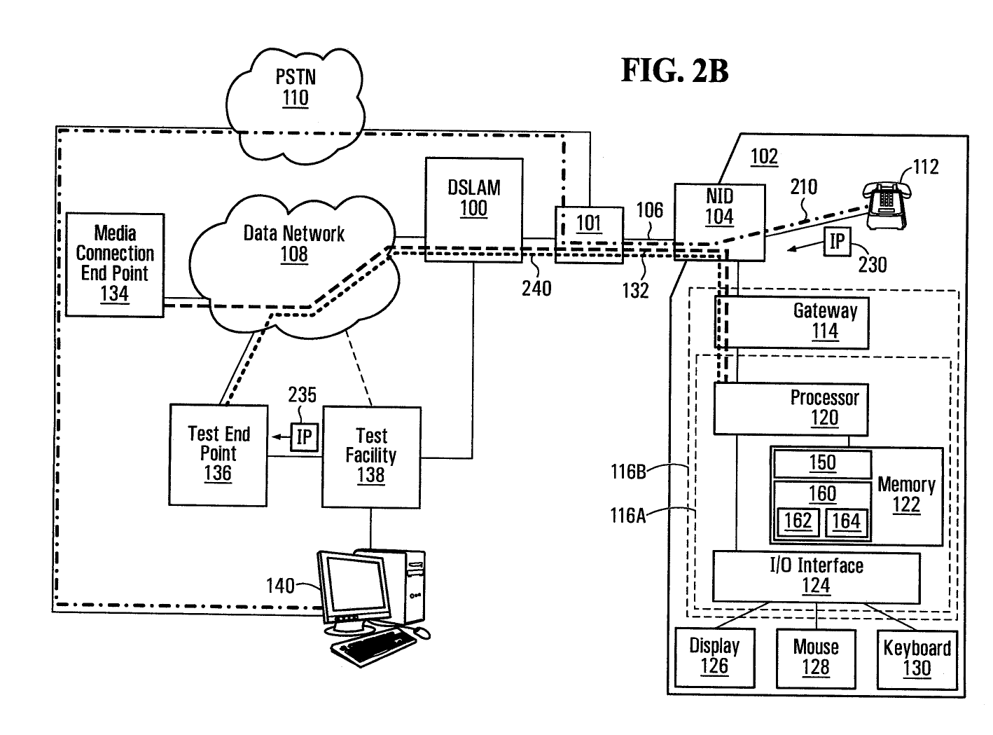

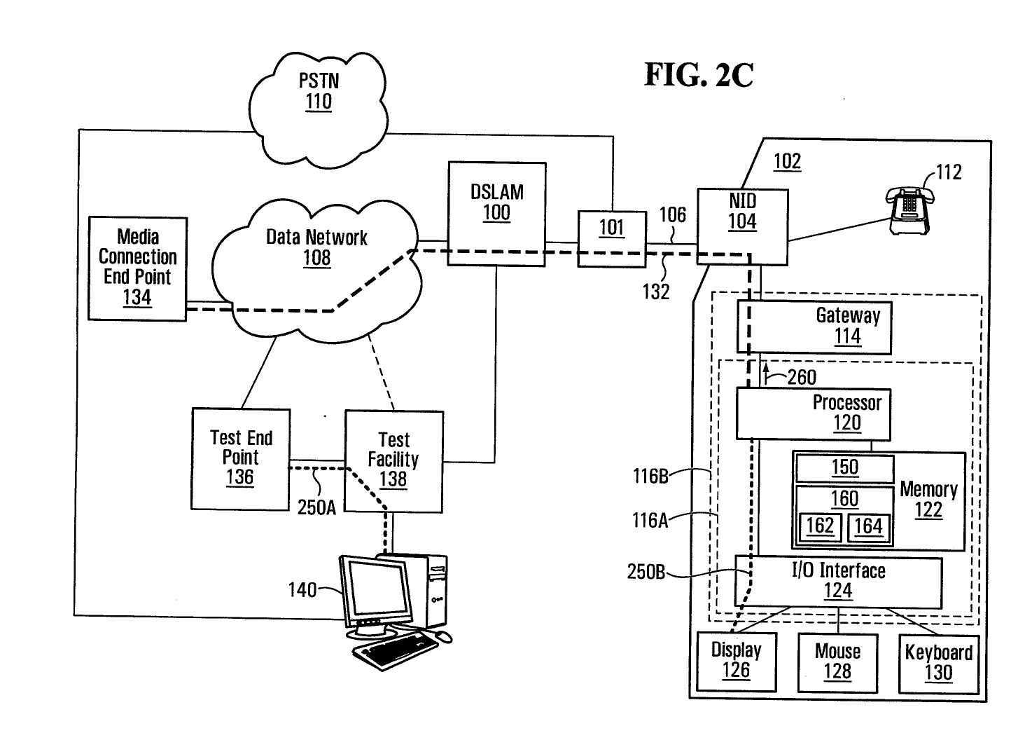

Scenario A (FIGS. 2A-2C)

With reference to FIG. 2A, the subscriber contacts a service technician 140 at a test facility 138 for assistance. In a non-limiting example embodiment, this can be done by dialing a known telephone number using the POTS telephone 112 at the subscriber premises 102. Thus, a telephony link 210 is established between the subscriber and the service technician 140, who is also using a telephone that may be connected to the PSTN 110.

In another non-limiting example embodiment, the subscriber may contact the service technician 140 using a telephone other than the POTS telephone 112. For example, the subscriber may contact the service technician 140 using a cellular telephone or a VoIP phone at the subscriber premises 102. In the case of a VoIP phone, and in the case where the subscriber is provided with Internet access as illustrated in FIG. 1, the telephony link established between the subscriber and the service technician 140 is in fact a data link that travels through the DSLAM 100 in the same fashion as the media connection 132.

It should be appreciated that some subscribers may be inclined to contact the service technician 140 only once they have performed certain local tests on their computing device 116A, 116B. Examples of local tests include emptying the computing device's 116A, 116B recycle bin, optimizing various Internet browser settings, clearing temporary internet files, and so on. Various software tools, occasionally referred to herein as “local self-help software applications”, are available for executing these types of local tests. For example, Bell Canada of Montreal, Quebec, Canada offers a local self-help software application (NetAssistant™) to its high-speed Internet subscribers. Computer-readable instructions defining operation of the local self-help software application, where one is available, can be stored in the memory 122 and readable by the processor 120.

Under the present scenario, namely Scenario A, the service technician 140 instructs the subscriber to invoke the aforementioned troubleshooting application 160. In accordance with a non-limiting embodiment of the present invention, the troubleshooting application 160 causes the processor 120 to execute a method in a sequence of processes, namely a provisioning process 162 followed by a testing process 164. During the testing process 164, a connectivity test is performed over a test connection established through the gateway 114 and over the data network 108. However, to enable establishment of the test connection, the provisioning process 162 needs to be executed first.

It is envisaged that in some embodiments, the provisioning process 162 and the testing process 164 may be two parts of a common software program, namely the troubleshooting application 160. In other embodiments, the provisioning process 162 and the testing process 164 may be embodied as distinct software programs. In still other embodiments, the provisioning process 162 and the testing process 164 may be components of a yet larger software program, which itself may include the aforementioned local self-help software application. Thus, under the present scenario, the provisioning process 162 and/or the troubleshooting application 160 may be launched directly by the subscriber or from within another software application, including from within the media application 150 and from within the local self-help software application.

As one possible action, the provisioning process 162 may verify whether the testing process 164 (i.e., that part of the troubleshooting application 160 which will later perform a connectivity test) has been installed. Such a verification can be done by accessing a configuration file in the memory 122, for example. If the testing process 164 has not been installed, instructions for execution of the testing process 164 may be downloaded by contacting a server in the data network 108 at a known IP address. The address of the server may be known by default, or it may be specified by the service technician 140 over the telephony link 210. An installation process may follow, which results in computer-readable instructions that define the testing process 164 being stored in the memory 122.

In addition, the provisioning process 162 may cause certain ports to be opened at the gateway 114. For example, when a firewall is in use at the gateway 114, it may be beneficial to open a TCP/IP port in order to make the gateway 114 visible over the data network 108 using the public IP address of the gateway 114. Stated differently, this action by the provisioning process 162 overrides some or all functionality of any existing firewall, thereby rendering the gateway 114 visible to a test end point 136, which is connected to the data network 108. Non-limiting examples of ports that may be opened for this purpose include one or more of 445, 10115 and 10116.

In addition, it may be beneficial to enable Internet Control Messaging Protocol (ICMP) messaging functionality at the gateway 114. ICMP is a network protocol useful in Internet Protocol (IP) network management and administration. Examples of ICMP messaging functionality that can be enabled include, without limitation: “incoming echo request”, “incoming timestamp request”, “incoming mask request”, “incoming router request”, “outgoing destination unreachable”, “outgoing source quench”, “outgoing parameter problem”, “outgoing time exceeded”, “redirect” and “outgoing packet too big”. It may be advantageous to enable still other protocol functionality, depending on the implementation. Such protocols include, without being limited to, simple object access protocol (SOAP), universal datagram protocol (UDP), hypertext transfer protocol (HTTP), and so on.

In order to open the requisite TCP/IP ports and enable the appropriate protocol functionality, the processor 120 may send a series of commands 220 to the gateway 114. Those skilled in the art will find it within the purview of their abilities to generate suitable commands for this purpose and therefore no further discussion of this aspect is required.

Variant 1
In a first variant, this may be the end of the provisioning process 162. The service technician 140 then obtains knowledge of the public IP address of the gateway 114 without assistance from the subscriber. For example, this can be achieved by the service technician 140, the test end point 136 or the test facility 138 accessing a database on the basis of subscriber credentials. The database, which maps subscriber credentials to IP addresses, may be populated and refreshed each time the subscriber accesses the data network 108.

Variant 2
In a second variant, with continued reference to FIG. 2A, the provisioning process 162 proceeds to obtain the public IP address of the gateway 114. This can be achieved by the processor 120 sending a series of commands 220 to the gateway 114, or accessing a database in the memory 122 where the IP address has been previously stored. Those skilled in the art will find it within the purview of their abilities to generate suitable commands or instructions for this purpose and therefore no further discussion of this aspect is required.
As shown in FIG. 2B, if the subscriber maintains the telephony link 210 with the service technician 140 while the provisioning process 162 is executing, the public IP address of the gateway 114 obtained in the aforementioned manner can be provided to the service technician 140 in a verbal message 230 conveyed via the telephony link 210. Alternatively, the gateway 114 or the processor 120 may send a message to the test facility 138 and/or to the test end point 136 through the data network 108, such message containing the public IP address of the gateway 140.

Once the service technician 140 knows the public IP address of the gateway 114, in accordance with either of the above variants, the service technician 140 instructs the subscriber to invoke the testing process 164. This can be done by conveying an instruction over the telephony link 210. In response to invoking the testing process 164 (e.g., by clicking a mouse, pressing a key, touching a display, etc.), the computing device 116A, 116B begins to await a handshake initiation from the test end point 136 to perform a connectivity test. Meanwhile, the processor 120 may continue to participate in the media connection 132 that originally exhibited symptoms of a connectivity problem. Alternatively, the processor 120 may terminate the media connection 132.

In addition, the service technician 140 communicates with the test facility 138, instructing it to coordinate a connectivity test with the computing device 116A, 116B. Specifically, the test facility 138 is connected to the test end point 136 either directly or through the data network 108. The test end point 136, which is pre-loaded with a suite of test software, may be reachable at a known IP address. The test facility 138 sends a message 235 to the test end point 136 specifying the public IP address of the gateway 114.

In response, the test end point 136 establishes a test connection 240 with the processor 120. For example, the test end point 136 may begin by initiating a handshake with the processor 120, which, by virtue of running the testing process 164, had been awaiting such a handshake initiation. In accordance with an embodiment of the present invention, the handshake initiation and the remainder of the test connection 240 may utilize the one or more ports at the gateway 114 that were opened by the provisioning process 162. This enables any firewalls on the gateway 114 to be bypassed for the purposes of the test connection 240. It can be assumed that the test end point 136 has knowledge of these ports, since the provisioning process 162 is under the control of the service provider.

At this stage, either autonomously or under the supervision of the service technician 140, the testing process 164 and the test end point 136 cooperate to carry out a connectivity test over the test connection 240 in order to measure features such as throughput, jitter, lost data, mean opinion scores (for VOIP) and media delivery index (for video over IP). Because the processor 120 may continue to participate in the media connection 132 that originally exhibited symptoms of a connectivity problem, the results of the connectivity test will be more accurate in reflecting the possible causes of the connectivity problem. It should also be appreciated that although the service technician 140 may be involved in establishing the test connection 240 and initiating the connectivity test, such supervision may be achieved remotely, without the need to deploy the service technician 140 to the subscriber premises 102.

In a non-limiting example, the connectivity test that can be carried out may include the tests enabled by the products promulgated by Ixia (http://www.ixiacom.com), such as IxChariot™. Further information about the IxChariot™ product can be found at http://www.ixiacom.com/support/chariot/appnotes/The_Synergy_of_Chariot_And_Protocol_Analyzers.pdf. The contents of the aforementioned documentation is hereby incorporated by reference herein.

Upon completion of the connectivity test, and with reference to FIG. 2C, the test results can be collected by the test end point 136 and sent to the test facility 138 along a data path 250A. At the test facility 138, the test results can be presented to the service technician 140 for further analysis.

In an alternative embodiment, or in addition, the test results can be collected by the troubleshooting application 160 and conveyed to the subscriber along a path 250B that involves the display 126.

In another alternative embodiment, the test results can be redacted into a user-friendly “report card”, which can be conveyed to the subscriber along the path 250B and displayed on the display 126. It is envisaged that redaction of the test results may in some embodiments comprise converting the test results into exclusively qualitative data (such as pass/fail; low/medium/high), etc. It should be appreciated that the provision of test results in a redacted fashion may provide the subscriber with sufficient qualitative information to gauge the severity of the connectivity problem, without burdening him or her with irrelevant quantitative information that may in fact cause him or her to overestimate the severity of the connectivity problem.

The subscriber may choose to keep the test results to himself or herself. Alternatively, the subscriber may verbally convey the displayed test results to the service technician 140 over the telephony link 210. With knowledge of the test results, the service technician 140 may be in a position to recommend action that will remedy the connectivity problem initially reported by the subscriber.

At this stage, the testing process 164 may be terminated. This can occur in response to recognizing that the test results have been displayed to and acknowledged by the subscriber. Alternatively, this can occur in response to a signal received from the test end point 136. Still alternatively, this can occur in response to receipt of user input via the mouse 128 or keyboard 130, for example, which signals a desire to exit the troubleshooting application 160. The troubleshooting application 160 may cause the processor 120 to execute several final steps to undo the effects of the provisioning process 162. Specifically, by issuing a set of commands 260 to the gateway 114, previously opened TCP/IP ports may be closed and previously enabled protocol functionality (e.g., ICMP, SOAP, UDP or HTTP messaging functionality) may be disabled or returned to the previous state. Those skilled in the art will find it within the purview of their abilities to generate suitable commands for this purpose and therefore no further discussion of this aspect is required.

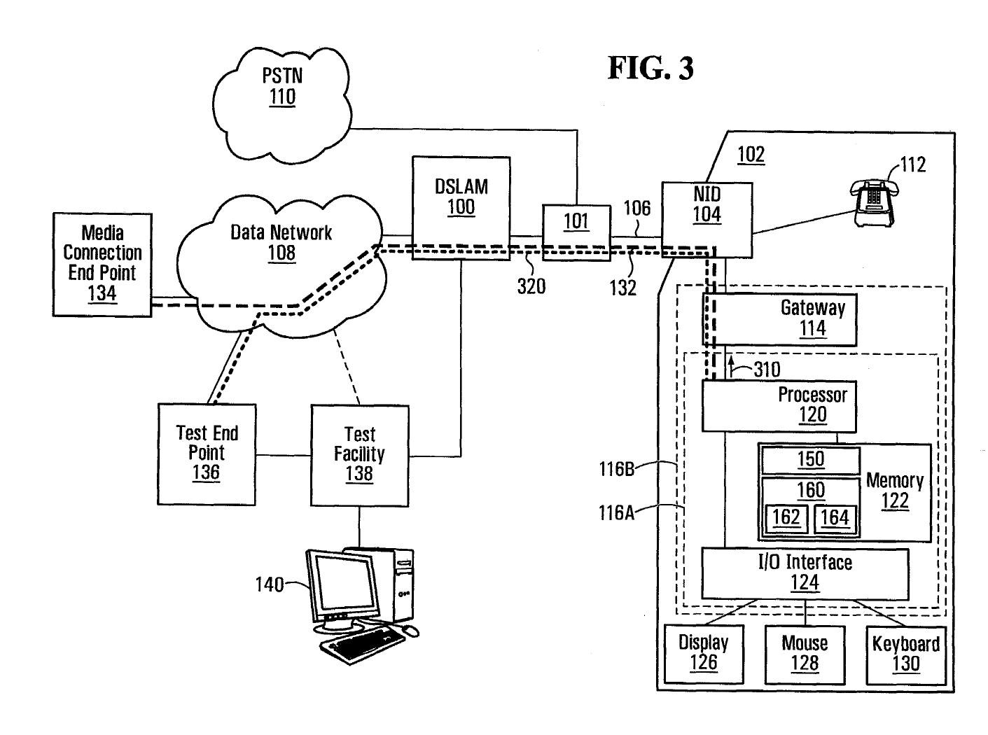

Scenario B (FIG. 3)

In this scenario, the test connection, rather than being initiated by the test end point 136, is initiated by the gateway 114 or the processor 120. To this end, there is no need for interaction between the subscriber and the service technician 140, although it may be reassuring to the subscriber or otherwise beneficial to maintain telephonic contact between the subscriber and the service technician.

Accordingly, with reference to FIG. 3, when the subscriber detects a connectivity problem, the subscriber invokes the troubleshooting application 160 from the computing device 116A, 116B (e.g., by providing subscriber input via the mouse 128 or keyboard 130). It is recalled that the troubleshooting application 160 comprises the provisioning process 162 and the testing process 164. As part of the provisioning process 162, the processor 120 sends a series of commands 310 to the gateway 114, which cause the requisite TCP/IP ports to be opened and the appropriate protocol functionality to be enabled at the gateway 114.

Next, the processor 120 proceeds with the testing process 164, which involves establishing a test connection 320 with the test end point 136 via the gateway 114 and over the data network 108. In order to enable the processor 120 to establish the test connection 320, the processor 120 obtains the IP address of the test end point 136. In one non-limiting example, the IP address of the test end point may be hard coded into the testing process 164 or accessed from a local source (e.g., look-up table) in the computing device 116A, 116B. In another non-limiting example, as part of the testing process 164 (or the provisioning process 162), the processor 120 may request the IP address of the test end point 136 from a known device. The known device in question may be a data server (not shown) that provides the computing device 116A, 116B with access to the data network 108, and thus its identity will be known to the processor 120.

The testing process 164 and the test end point 136 then cooperate to carry out a connectivity test over the test connection 320 as previously described, i.e., in order to measure features such as throughput, jitter, lost data, mean opinion scores (for VOIP) and media delivery index (for video over IP). Because the processor 120 may continue to participate in the media connection 132 that originally exhibited symptoms of a connectivity problem, the results of the connectivity test will be more accurate in reflecting the possible causes of the connectivity problem. It should also be appreciated that there is no need to deploy a service technician to the subscriber premises 102.

Upon completion of the connectivity test, the test results can be collected by the troubleshooting application 160 and conveyed to the subscriber via the display 126. As previously mentioned, the test results can be redacted into a user-friendly report card. Alternatively, as part of the troubleshooting application 160, the processor 120 may analyze the test results to determine the severity of the connectivity problem. The processor 120 may send a message via the gateway 114 and the data network 108, such message (which can be referred to as a “trouble ticket”) including an indication of the severity of the connectivity problem as well as the subscriber afflicted with this connectivity problem. The trouble ticket may be sent to the test facility 138. Upon receipt of the trouble ticket, the service technician 140 can begin addressing the connectivity problem and/or may call the subscriber to request further information regarding the connectivity problem.

In one embodiment, upon receipt of the trouble ticket at the test facility 138, the test facility 138 could automatically trigger a call between the subscriber and either the service technician 140 or a call center for technical support. In this case, the telephone number to contact the subscriber could be accessed from a database that links subscriber identifiers with subscriber contact telephone numbers. Alternatively, the telephone number to contact the subscriber could be received from the subscriber after prompting the subscriber through the display 126. In this case, the subscriber could type in the preferred contact telephone number using the keyboard 130, and the processor 120 could send the received contact telephone number to the test facility 138 via the data network 108 either within the trouble ticket or in a separate message. The call between the subscriber and either the service technician 140 or the call center can be accomplished through (a) the initiation of two voice call legs, one to the subscriber and one to the service technician 140 or the call center; and (b) bridging of the two voice call legs together. It should be understood that these call legs could be initiated via the PSTN 110 or through VoIP connections.

The subscriber may choose to keep the test results to himself or herself. Alternatively, the subscriber may verbally convey the displayed test results to the service technician 140 over a telephony link. With knowledge of the test results, the service technician 140 may be in a position to recommend action that will remedy the connectivity problem initially reported by the subscriber.

At this stage, the testing process 164 may be terminated. This can occur in response to recognizing that the test results have been displayed to and acknowledged by the subscriber. Alternatively, this can occur in response to a signal received from the test end point 136. Still alternatively, this can occur in response to receipt of user input via the mouse 128 or keyboard 130, for example, which signals a desire to exit the troubleshooting application 160. The troubleshooting application 160 may cause the processor 120 to execute several final steps to undo the effects of the provisioning process 162. Specifically, by issuing a set of commands to the gateway 114, previously opened TCP/IP ports may be closed and previously enabled protocol functionality (e.g., ICMP, SOAP, UDP or HTTP messaging functionality) may be disabled or returned to the previous state. Those skilled in the art will find it within the purview of their abilities to generate suitable commands for this purpose and therefore no further discussion of this aspect is required.

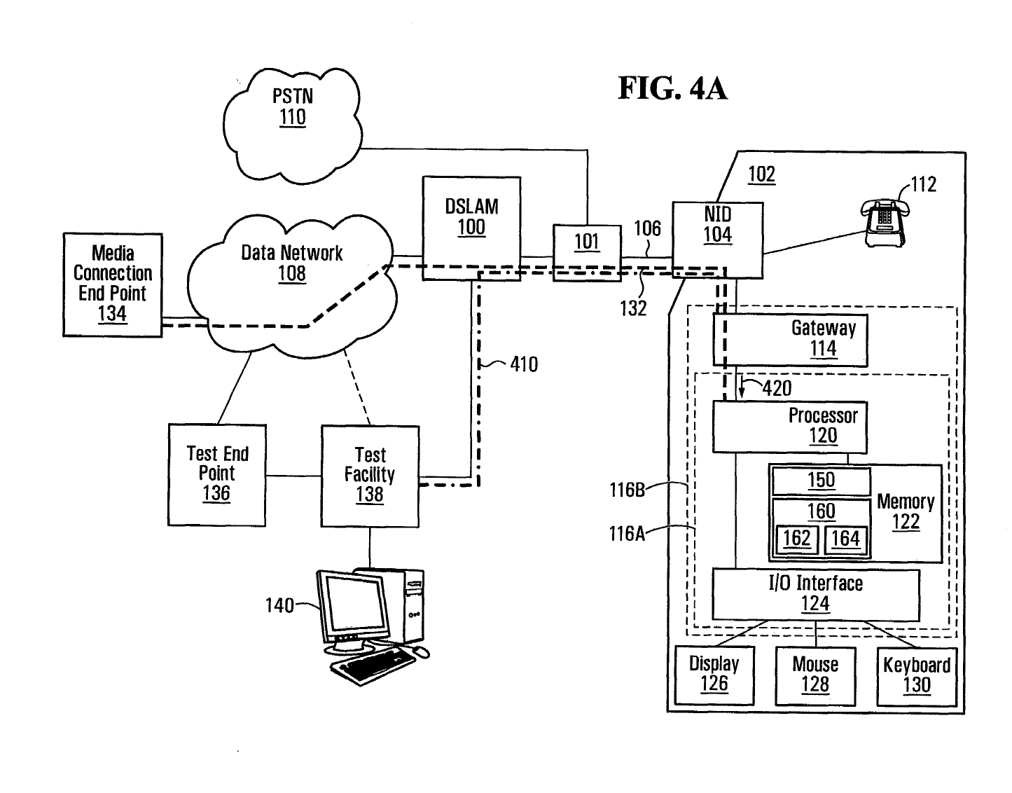

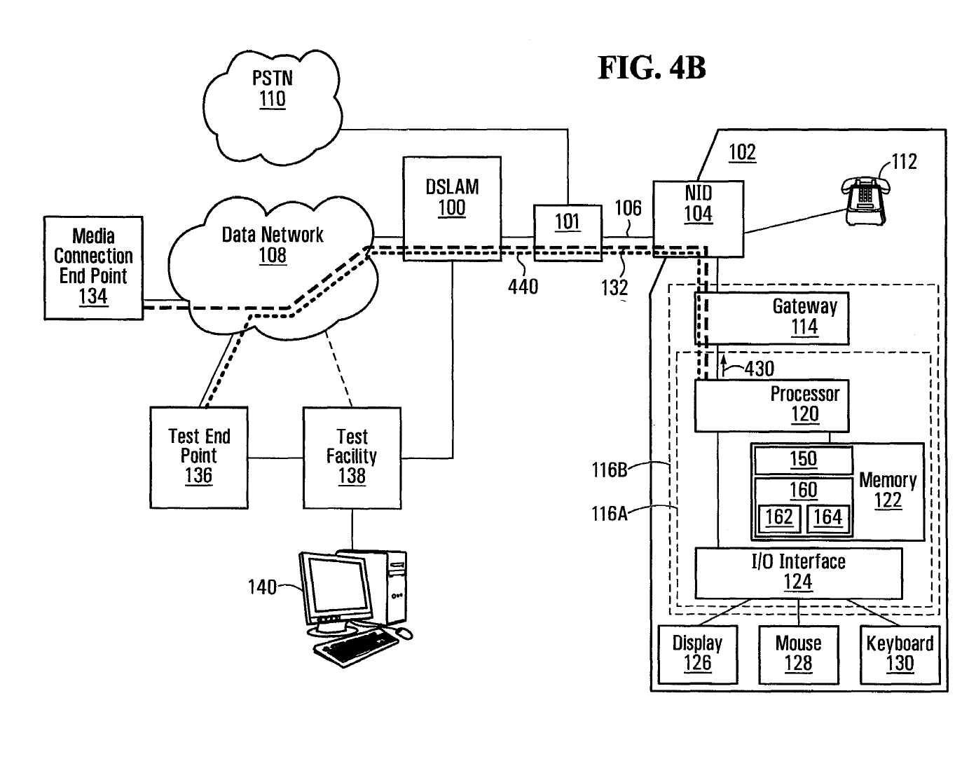

Scenario C (FIGS. 4A-4B)

In this scenario, the service technician 140 is involved, but the subscriber does less work than in the previous scenarios or potentially no work at all. Specifically, with reference to FIG. 4A, the service technician 140 establishes a private path 410 between the test facility 138 and the gateway 114. Specifically, this may be achieved by providing a connection between the test facility 138 and a management port on the DSLAM 100. The service technician 140 then instructs the test facility 138 to trigger the gateway 114 to issue a command 420 to the processor 120 (e.g., via the operating system). In an embodiment of the present invention, the command 420 serves to invoke the troubleshooting application 160.

It is recalled that the troubleshooting application 160 comprises the provisioning process 162 and the testing process 164. As part of the provisioning process 162, and with reference to FIG. 4B, the processor 120 sends a series of commands 430 to the gateway 114, which cause the requisite TCP/IP ports to be opened and the appropriate protocol functionality to be enabled at the gateway 114.

Next, the processor 120 proceeds with the testing process 164, which involves establishing a test connection 440 with the test end point 136 via the gateway 114 and over the data network 108. In order to enable the processor 120 to establish the test connection 440, the processor 120 obtains the IP address of the test end point 136. In one non-limiting example, the IP address of the test end point may be hard coded into the testing process 164 or accessed from a local source (e.g., look-up table) in the computing device 116A, 116B. In another non-limiting example, as part of the testing process 164 (or the provisioning process 162), the processor 120 may request the IP address of the test end point 136 from a known device. The known device in question may be a data server (not shown) that provides the computing device 116A, 116B with access to the data network 108, and thus its identity will be known to the processor 120. In yet another non-limiting example, the IP address of the test end point 136 may be provided by the test facility 138 over the private path 410.

The testing process 164 and the test end point 136 then cooperate to carry out a connectivity test over the test connection 440 as previously described, i.e., in order to measure features such as throughput, jitter, lost data, mean opinion scores (for VoIP) and media delivery index (for video over IP). Because the processor 120 may continue to participate in the media connection 132 that originally exhibited symptoms of a connectivity problem, the results of the connectivity test will be more accurate in reflecting the possible causes of the connectivity problem. It should also be appreciated that there is no need to deploy the service technician 140 to the subscriber premises 102.

It should be noted that this scenario, namely Scenario C, permits the troubleshooting application 160 to be invoked by the service technician 140, without requiring subscriber participation and without requiring the subscriber to be in telephonic communication with the service technician 140. This can allow for more efficient human resource allocation and service prioritization by the service provider.

Upon completion of the connectivity test, and similarly to what was described herein above with reference to Scenario A, the test results can be collected by the test end point 136 and sent to the facility 138. At the test facility 138, the test results can be presented to the service technician 140 for further analysis. With knowledge of the test results, the service technician 140 may be in a position to recommend action that will remedy the connectivity problem initially reported by the subscriber.

In an alternative embodiment, or in addition, the test results can be collected by the troubleshooting application 160 and conveyed to the subscriber via the display 126 in the form of an alert. As mentioned previously, the test results may be redacted into a user-friendly report card, which can be conveyed to the subscriber via the display 126.

At this stage, the testing process 164 may be terminated. This can occur in response to recognizing that the test results have been displayed to and acknowledged by the subscriber. Alternatively, this can occur in response to a signal received from the test end point 136. Still alternatively, this can occur in response to receipt of user input via the mouse 128 or keyboard 130, for example, which signals a desire to exit the troubleshooting application 160. The troubleshooting application 160 may cause the processor 120 to execute several final steps to undo the effects of the provisioning process 162. Specifically, by issuing a set of commands to the gateway 114, previously opened TCP/IP ports may be closed and previously enabled protocol functionality (e.g., ICMP, SOAP, UDP or HTTP messaging functionality) may be disabled or returned to the previous state. Those skilled in the art will find it within the purview of their abilities to generate suitable commands for this purpose and therefore no further discussion of this aspect is required.

While specific embodiments of the present invention have been described and illustrated, it will be apparent to those skilled in the art that numerous modifications and variations can be made without departing from the scope of the invention as defined in the appended claims.

What is claimed is:

1. A computer-readable medium comprising a set of instructions for execution by a processor of a computing device at a subscriber premises, the processor being operable to execute a software application that enables the computing device to participate in a media connection over a data network, wherein execution of the set of instructions by the processor causes the computing device to execute a method that includes:
performing a connectivity test over a test connection established through a gateway at the subscriber premises and over the data network;
prior to said performing a connectivity test, provisioning the gateway to enable establishment of said test connection.

2. The computer-readable medium defined in claim 1, wherein the computing device comprises the gateway.

3. The computer-readable medium defined in claim 1, wherein the gateway is implemented as a router.

4. The computer-readable medium defined in claim 1, wherein the gateway is implemented as a modem.

5. The computer-readable medium defined in claim 1, the method further comprising receiving a handshake initiation from a test facility via the gateway, wherein said provisioning the gateway is performed in response to receipt of said handshake initiation.

6. The computer-readable medium defined in claim 1, the method further including, prior to said performing a connectivity test, performing a local test of the computing device without involving the data network.

7. The computer-readable medium defined in claim 1, the method further including, prior to said performing a connectivity test, downloading from a server in the data network a set of instructions for running the connectivity test.

8. The computer-readable medium defined in claim 1, the method further including, prior to said performing a connectivity test, downloading from a server in the data network a set of instructions for effecting said provisioning.

9. The computer-readable medium defined in claim 1, wherein said provisioning the gateway is effected in response to input received from a user of the computing device.

10. The computer-readable medium defined in claim 9, wherein said input comprises at least one of a mouse click, a key stroke and a pen stroke.

11. The computer-readable medium defined in claim 1, wherein said provisioning the gateway is effected in response to a trigger received from said software application.

12. The computer-readable medium defined in claim 1, the processor being operable to execute a local diagnostic application, wherein said provisioning the gateway is effected in response to a trigger received from said local diagnostic application.

13. The computer-readable medium defined in claim 1, wherein the test connection is established with a test apparatus reachable over the data network.

14. The computer-readable medium defined in claim 1, wherein said provisioning the gateway comprises communicating with the gateway to open a TCP/IP port at the gateway.

15. The computer-readable medium defined in claim 14, wherein said provisioning the gateway comprises communicating with the gateway to enable at least one of ICMP, SOAP, UDP and HTTP messaging at the gateway.

16. The computer-readable medium defined in claim 1, wherein said provisioning the gateway comprises communicating with the gateway to obtain a public IP address assigned to the gateway.

17. The computer-readable medium defined in claim 16, the method further comprising sending the public IP address to a test facility via the gateway.

18. The computer-readable medium defined in claim 1, the method further including collecting results reflective of an outcome of the connectivity test.

19. The computer-readable medium defined in claim 18, the method further including causing said results to be displayed by a display device at the subscriber premises.

20. The computer-readable medium defined in claim 19, the method further including redacting said results prior to causing said results to be displayed by the display device.

21. The computer-readable medium defined in claim 20, wherein redacting said results comprises rendering the results exclusively qualitative.

22. The computer-readable medium defined in claim 18, the method further including causing said results to be sent to a test facility reachable over the data network.

23. The computer-readable medium defined in claim 1, the method further including, upon completion of said connectivity test, provisioning the gateway to disable said test connection.

24. The computer-readable medium defined in claim 23, wherein said provisioning the gateway to disable said test connection comprises communicating with the gateway to close a previously opened TCP/IP port at the gateway.

25. The computer-readable medium defined in claim 24, wherein said provisioning the gateway to disable said test connection comprises communicating with the gateway to disable at least one of ICMP, SOAP, UDP and HTTP messaging at the gateway.

26. The computer-readable medium defined in claim 1, wherein the media connection is at least one of a voice connection, a video connection and a data connection.

27. A method for execution at a computing device located at a subscriber premises, comprising:
executing a software application that enables the computing device to participate in a media connection over a data network;
performing a connectivity test over a test connection established through a gateway at the subscriber premises and over the data network;
prior to said performing a connectivity test, provisioning the gateway to enable establishment of said test connection.

28. The method defined in claim 27, wherein said performing a connectivity test is effected during execution of said software application.

29. The method defined in claim 27, further comprising:
invoking a local diagnostic application to diagnose a local problem affecting the computing device without involving the data network.

30. The method defined in claim 29, wherein said provisioning the gateway is triggered by said local diagnostic application.

31. The method defined in claim 27, wherein said provisioning the gateway is triggered by receipt of input from a user of said computing device.

32. The method defined in claim 31, wherein said input from a user is received in response to the user entering into communication with a service technician.

33. The method defined in claim 27, further comprising receiving a handshake initiation from a test facility via the gateway, wherein said provisioning the gateway is performed in response to receipt of said handshake initiation.

34. The method defined in claim 27, the method further including, prior to said performing a connectivity test, performing a local test of the computing device without involving the data network.

35. The method defined in claim 27, further including, prior to said performing a connectivity test, downloading from a server in the data network a set of instructions for running the connectivity test.

36. The method defined in claim 27, further including, prior to said performing a connectivity test, downloading from a server in the data network a set of instructions for effecting said provisioning.

37. The method defined in claim 27, wherein the test connection is established with a test apparatus reachable over the data network.

38. The method defined in claim 27, wherein provisioning the gateway comprises communicating with the gateway to open a TCP/IP port at the gateway.

39. The method defined in claim 38, wherein said provisioning the gateway comprises communicating with the gateway to enable ICMP messaging at the gateway.

40. The method defined in claim 27, wherein said provisioning the gateway comprises communicating with the gateway to obtain a public IP address assigned to the gateway.

41. The method defined in claim 40, further comprising sending the public IP address to a test facility via the gateway.

42. The method defined in claim 27, the method further including, upon completion of said connectivity test, provisioning the gateway to disable said test connection.

43. The method defined in claim 42, wherein said provisioning the gateway to disable said test connection comprises communicating with the gateway to close a previously opened TCP/IP port at the gateway.

44. The method defined in claim 43, wherein said provisioning the gateway to disable said test connection comprises communicating with the gateway to disable ICMP messaging at the gateway.

45. The method defined in claim 27, further including collecting results reflective of an outcome of the connectivity test.

46. The method defined in claim 45, further including causing said results to be displayed by a display device at the subscriber premises.

47. The method defined in claim 46, further including redacting said results prior to causing said results to be displayed by the display device.

48. The method defined in claim 47, wherein redacting said results comprises rendering the results exclusively qualitative.

49. The method defined in claim 45, further including causing said results to be sent to a server reachable over the data network.

50. The method defined in claim 27, wherein the media connection is at least one of a voice connection, a video connection and a data connection.

51. A method for execution at a computing device located at a subscriber premises, the computing device being operable for executing a software application that enables the computing device to participate in a media connection over a data network, the method comprising:
performing a connectivity test over a test connection established through a gateway at the subscriber premises and over the data network;
prior to said performing a connectivity test, provisioning the gateway to enable establishment of said test connection.

52. A system for testing connectivity over a data network, the system comprising:
a test end point accessible via the data network;
a computing device operable for executing a software application that enables the computing device to participate in a media connection over the data network,
the test end point operable for issuing a test initiation trigger to the computing device;
the computing device further operable for responding to said test initiation trigger to effect a connectivity test over a test connection established with the test end point, the computing device further operable for, prior to said performing a connectivity test, provisioning the computing device to enable establishment of said test connection.
